(19) United States
(12) Patent Application Publication
(10) Pub. No.: US 2021/0220828 A1
(43) Pub. Date: Jul. 22, 2021

(54) BIOLOGICAL DETECTION SUBSTRATE, MICROFLUIDIC CHIP AND DRIVING METHOD THEREOF, MICROFLUIDIC DETECTION COMPONENT

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Haochen CUI, Beijing (CN); Wenliang YAO, Beijing (CN); Peizhi CAI, Beijing (CN); Chuncheng CHE, Beijing (CN); Yingying ZHAO, Beijing (CN); Yuelei XIAO, Beijing (CN); Le GU, Beijing (CN); Yue GENG, Beijing (CN); Nan ZHAO, Beijing (CN); Hui LIAO, Beijing (CN); Fengchun PANG, Beijing (CN)

(73) Assignees: Beijing BOE Optoelectronics Technology Co., Ltd., Beijing (CN); BOE Technology Group Co., Ltd., Beijing (CN)

(21) Appl. No.: 16/631,984

(22) PCT Filed: Jan. 15, 2019
(86) PCT No.: PCT/CN2019/071802

§ 371 Date: Jan. 17, 2020

(51) Int. Cl. B01L 3/00

(52) U.S. Cl. CPC B01L 3/502784; B01L 2400/0415; B01L 2300/161; B01L 2200/027; B01L 2300/0887

(57) ABSTRACT

A biological detection substrate, a microfluidic chip and a driving method thereof, and a microfluidic detection component are provided. The biological detection substrate includes a sample capture region, the sample capture region includes an electromagnetic coil, and the electromagnetic coil is configured to capture a sample in a sample droplet that is driven to pass through the sample capture region.

### TECHNICAL FIELD

Embodiments of the present disclosure relate to a biological detection substrate, a microfluidic chip and a driving method thereof, and a microfluidic detection component.

### BACKGROUND

In a technology field of biochemical analysis and detection, microfluidic technology may be used for perform basic operations such as sample preparation, reaction, separation, detection, and so on, and microfluidic chips are main platforms for achieving microfluidic technology. Microfluidic technology has been developed to reduce the amount of samples and reagents to achieve miniaturization and high integration. However, when detecting some low-concentration biological samples, the amount of samples and reagents on the microfluidic chip is too small, which leads to failure of the detection and analysis results. In order to better detect low-concentration biological samples, the biological samples need to be pre-gathered before detection, and then detection and analysis are performed on the biological samples.

### SUMMARY

At least one embodiment of the present disclosure provides a biological detection substrate, and the biological detection substrate comprises a sample capture region, the sample capture region comprises an electromagnetic coil, and the electromagnetic coil is used to capture a sample in a sample droplet that is driven to pass through the sample capture region.

For example, the biological detection substrate provided by at least one embodiment of the present disclosure further comprises a droplet transmission channel, the droplet transmission channel is in connection with the sample capture region, and is used to drive the sample droplet, that is injected and contains the sample, to the sample capture region.

For example, in the biological detection substrate provided by at least one embodiment of the present disclosure, the sample capture region further comprises a first driving unit, and the first driving unit comprises a first driving electrode.

For example, the biological detection substrate provided by at least one embodiment of the present disclosure further comprises a base substrate, the droplet transmission channel and the sample capture region are on the base substrate, the first driving electrode and the electromagnetic coil are in a same layer with respect to the base substrate, the first driving electrode comprises a hollow-out region, and the electromagnetic coil is in the hollow-out region; or the electromagnetic coil surrounds the first driving electrode.

For example, the biological detection substrate provided by at least one embodiment of the present disclosure further comprises a base substrate, the droplet transmission channel and the sample capture region are on the base substrate, the first driving electrode and the electromagnetic coil are in different layers with respect to the base substrate, in a direction perpendicular to the base substrate, the first driving electrode and the electromagnetic coil are at least partially overlapped with each other.

For example, in the biological detection substrate provided by at least one embodiment of the present disclosure, the sample capture region further comprises a plurality of first driving units, each of the plurality of first driving units comprises a first driving electrode, and the sample capture region comprises at least one electromagnetic coil.

For example, the biological detection substrate provided by at least one embodiment of the present disclosure further comprises a base substrate, the droplet transmission channel and the sample capture region are on the base substrate, the plurality of first driving units and the at least one electromagnetic coil are in a same layer with respect to the base substrate, the first driving electrode of at least one first driving unit of the plurality of first driving units comprises a hollow-out region, and the at least one electromagnetic coil is in the hollow-out region; or the at least one electromagnetic coil surrounds the first driving electrode of the at least one first driving unit of the plurality of first driving units.

For example, the biological detection substrate provided by at least one embodiment of the present disclosure further comprises a base substrate, the droplet transmission channel and the sample capture region are on the base substrate, the plurality of first driving units are in a same layer with respect to the base substrate, and with respect to the base substrate, a layer where the plurality of first driving units are located is different from a layer where the at least one electromagnetic coil are located, in a direction perpendicular to the base substrate, the first driving electrode of at least one first driving unit of the plurality of first driving units and the at least one electromagnetic coil are overlapped with each other.

For example, in the biological detection substrate provided by at least one embodiment of the present disclosure, the first driving electrode is made of a soft magnetic material.

For example, in the biological detection substrate provided by at least one embodiment of the present disclosure, the droplet transmission channel comprises a plurality of second driving units, the plurality of second driving units are arranged along a predetermined route, and each of the plurality of second driving units comprises a second driving electrode.

For example, in the biological detection substrate provided by at least one embodiment of the present disclosure, the second driving electrode and the first driving electrode are in a same layer with respect to the base substrate.

For example, in the biological detection substrate provided by at least one embodiment of the present disclosure, the electromagnetic coil is of a planar spiral type or a three-dimensional spiral type.

For example, the biological detection substrate provided by at least one embodiment of the present disclosure further comprises a sample liquid injection region, the droplet transmission channel comprises a first channel, and the first channel is used to connect the sample liquid injection region and the sample capture region.

For example, in the biological detection substrate provided by at least one embodiment of the present disclosure, the sample liquid injection region comprises a first sample liquid injection electrode and a second sample liquid injection electrode, the first sample liquid injection electrode comprises a first notch, and the second sample liquid injection electrode is in the first notch.

For example, the biological detection substrate provided by at least one embodiment of the present disclosure further comprises a cleaning liquid injection region, the droplet transmission channel comprises a second channel, and the second channel is used to connect the cleaning liquid injection region and the sample capture region.

For example, in the biological detection substrate provided by at least one embodiment of the present disclosure, the cleaning liquid injection region comprises a first cleaning liquid injection electrode and a second cleaning liquid injection electrode, the first cleaning liquid injection electrode comprises a second notch, and the second cleaning liquid injection electrode is in the second notch.

For example, the biological detection substrate provided by at least one embodiment of the present disclosure further comprises a waste liquid gathering region, the waste liquid gathering region comprises a waste liquid gathering electrode, the droplet transmission channel comprises a third channel, and the third channel is used to connect the waste liquid gathering region and the sample capture region.

For example, the biological detection substrate provided by at least one embodiment of the present disclosure further comprises a dielectric layer and a first hydrophobic layer, the dielectric layer covers the droplet transmission channel and the sample capture region, and the first hydrophobic layer is on a side of the dielectric layer away from the droplet transmission channel and the sample capture region.

At least one embodiment of the present disclosure provides a microfluidic chip, the microfluidic chip comprises a first substrate and a second substrate, the first substrate and the second substrate are disposed opposite to each other, and the first substrate is any one of the above biological detection substrates.

For example, in the microfluidic chip provided by at least one embodiment of the present disclosure, the second substrate comprises a second hydrophobic layer, and the second hydrophobic layer is on a side of the second substrate close to the first substrate.

At least one embodiment of the present disclosure provides a microfluidic detection component, and the microfluidic detection component comprises any one of the above microfluidic chips and a magnetic particle.

For example, in the microfluidic detection component provided by at least one embodiment of the present disclosure, the magnetic particle is configured to be capable of coating a sample to be tested on a surface of the magnetic particle.

At least one embodiment of the present disclosure provides a driving method for driving any one of the above microfluidic chips, the driving method comprises: applying a first driving voltage signal group to the microfluidic chip, so as to drive the sample droplet containing a magnetic particle to move to the sample capture region; and applying a control current to the electromagnetic coil, so as to control the magnetic particle in the sample droplet to be gathered in the sample capture region.

For example, the driving method provided by at least one embodiment of the present disclosure further comprises: applying a second driving voltage signal group to the microfluidic chip, so as to control a cleaning droplet to move to the sample capture region to achieve to clean the sample capture region.

### BRIEF DESCRIPTION OF THE DRAWINGS

In order to demonstrate clearly technical solutions of the embodiments of the present disclosure, the accompanying drawings in relevant embodiments of the present disclosure will be introduced briefly. It is apparent that the drawings may only relate to some embodiments of the disclosure and not intended to limit the present disclosure.

FIG. 1A is a schematic block diagram of a biological detection substrate provided by some embodiments of the present disclosure;

FIG. 1B is a schematic plane diagram of a biological detection substrate provided by some embodiments of the present disclosure;

FIG. 2A is a schematic partial sectional structure diagram of a sample capture region on a biological detection substrate provided by some embodiments of the present disclosure;

FIG. 2B is a schematic partial sectional structure diagram of another sample capture region on a biological detection substrate provided by some embodiments of the present disclosure;

FIG. 3 is a schematic plane diagram of another biological detection substrate provided by some embodiments of the present disclosure;

FIG. 4A is a schematic plane diagram of further another biological detection substrate provided by some embodiments of the present disclosure;

FIG. 4B is a schematic partial sectional structure diagram of further another sample capture region on a biological detection substrate provided by some embodiments of the present disclosure;

FIG. 5 is a schematic plane diagram of still another biological detection substrate provided by some embodiments of the present disclosure;

FIGS. 6A-6C are schematic diagrams of moving droplets by a second driving unit;

FIG. 7 is a schematic plane diagram of further another biological detection substrate provided by some embodiments of the present disclosure;

FIG. 8 is a schematic block diagram of a microfluidic chip provided by some embodiments of the present disclosure;

FIG. 9 is a schematic partial sectional structure diagram of a sample capture region in a microfluidic chip provided by some embodiments of the present disclosure;

FIG. 10 is a schematic block diagram of a microfluidic detection component provided by some embodiments of the present disclosure;

FIG. 11 is a schematic flow diagram of a driving method of a microfluidic chip provided by some embodiments of the present disclosure; and

FIGS. 12A-12C are schematic diagrams of a sample pre-gathered process provided by some embodiments of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is apparent that the described embodiments are just a part but not all of the embodiments of the disclosure. Based on the described embodiments herein, those skilled in the art may obtain other embodiment, without any creative work, which shall be within the scope of the disclosure.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present disclosure, are not intended to indicate any sequence, amount or importance, but for distinguishing various components. The terms, such as “comprise/comprising,” “comprise/comprising,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may comprise an electrical connection/coupling, directly or indirectly. The terms, “on,” “under,” “left,” “right,” or the like are only used to indicate relative position relationship, and when the position of the object which is described is changed, the relative position relationship may be changed accordingly.

In order to keep the following descriptions of the embodiments of the present disclosure clear and concise, the present disclosure omits detailed descriptions of known functions and known components.

Traditional sample pre-gathered process usually uses manual processing method outside the microfluidic chip, but the manual processing method is easy to introduce contamination or partial loss of the original solution. In addition, this method is generally complicated to operate and consumes a lot of manpower and material resources. In order to reduce contamination and sample loss, and achieve a highly integrated and highly automated microfluidic chip, on-chip pre-gathered methods are increasingly used. In many biological analysis and detection scenarios, surfaces of magnetic particles, such as magnetic beads, are coated with the biological samples to be tested (for example, antibodies in an immune response). Once these magnetic beads are placed in a sufficiently strong magnetic field, the magnetic beads are attracted to one place by the attraction of the magnetic field, so that the samples to be tested are pre-gathered. At present, most microfluidic chips use external magnets to attract the magnetic beads coated with the samples, thereby achieving the pre-gathered process. However, the existence of external magnets has hindered the development of microfluidic chips towards high integration.

Some embodiments of the present disclosure provides a biological detection substrate, a microfluidic chip and a driving method thereof, and a microfluidic detection component. By integrating the magnetic control function directly on the biological detection substrate, the magnetic particles dispersed in the droplets can be captured on a surface of a chip, thereby achieving the pre-gathered process of the samples, and no additional magnet is required to capture the magnetic particles, which improves the integration degree of the chip, and reduces unnecessary external equipment. In addition, using a digital microfluidic chip, both sample droplets and cleaning droplets can be automatically generated and moved on the chip under the action of an electric field, which avoids manual operations, further improves the efficiency and automation degree of the pre-gathered process, and provides great convenience for the subsequent sample detection and analysis.

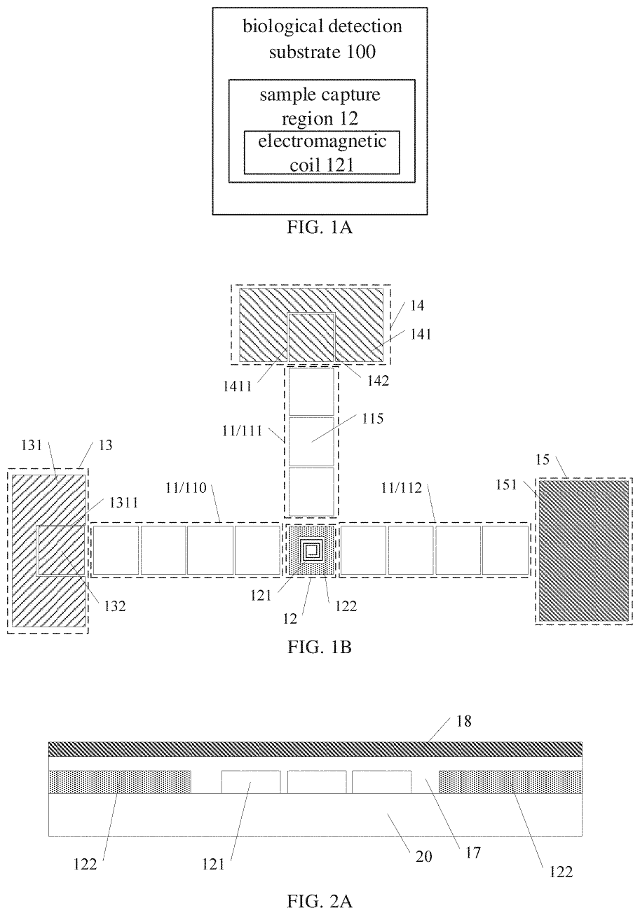

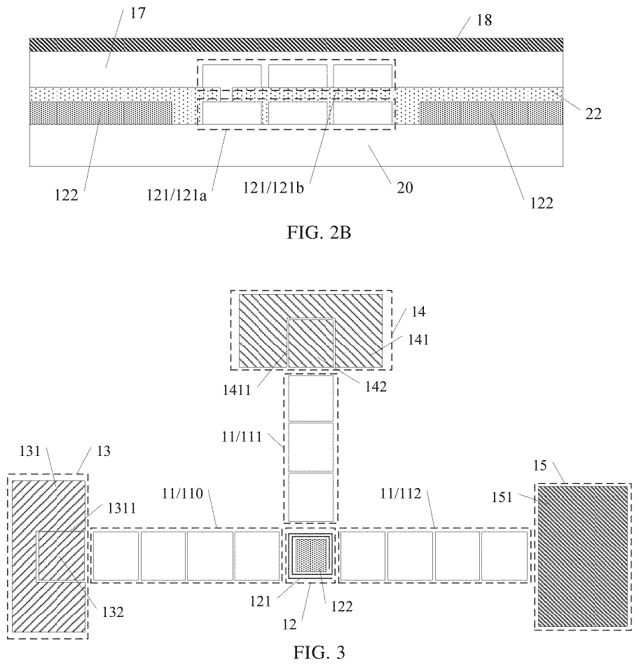

FIG. 1A is a schematic block diagram of a biological detection substrate provided by sonic embodiments of the present disclosure; FIG. 1B is a schematic plane diagram of a biological detection substrate provided by some embodiments of the present disclosure; FIG. 2A is a schematic partial sectional structure diagram of a sample capture region on a biological detection substrate provided by some embodiments of the present disclosure; FIG. 2B is a schematic partial sectional structure diagram of another sample capture region on a biological detection substrate provided by some embodiments of the present disclosure; and FIG. 3 is a schematic plane diagram of another biological detection substrate provided by some embodiments of the present disclosure.

For example, as shown in FIG. 1A, a biological detection substrate 100 provided in the embodiments of the present disclosure comprises a sample capture region 12. The sample capture region 12 comprises an electromagnetic coil 121. The electromagnetic coil 121 is used to capture a sample in a sample droplet that is driven to pass through the sample capture region 12, so as to gather the sample to the sample capture region 12.

Compared with the samples dispersed in sample droplets, the gathered samples are easier to be detected and analyzed. For example, in practical application scenarios, many biological samples (such as proteins or nucleic acids, etc.) can be coated on surfaces of magnetic particles, thereby utilizing the characteristics (i.e., magnetic properties) of the magnetic particles to facilitate sample gathering. In the embodiments of the present disclosure, the electromagnetic coil 121 is provided on the biological detection substrate 100, and the electromagnetic coil 121 can generate a magnetic field to gather the magnetic particles dispersed in the sample droplets and coated with the samples to the sample capture region 12, thereby achieving the pre-gathered process of the sample.

For example, as shown in FIG. 1B, the biological detection substrate 100 further comprises a droplet transmission channel 11, and the droplet transmission channel 11 is in connection with the sample capture region 12 and is used to drive the injected sample droplet containing the sample to the sample capture region 12.

For example, detection and analysis of the sample may be performed in the sample capture region 12. Based on different detection principles, the detection of the sample may comprises optical detection (for example, comprising fluorescence detection, absorbance detection, chemiluminescence detection, and so on), electrochemical detection (for example, comprising current detection, impedance detection, and so on), magnetoresistance detection, and so on. The optical detection is to determine various indicators of the sample by detecting various parameters of light; the electrochemical detection is to obtain the content of the sample or certain electrochemical properties indicating the sample by detecting the electrical response of the sample, for example, by measuring the change in current flowing through the sample or the change in impedance generated by the sample, or the like.

For example, the electromagnetic coil 121 is configured to generate a magnetic field based on a control current to control the magnetic particles in the sample droplet to be gathered to the sample capture region 12.

For example, the electromagnetic coil 121 may be formed by spirally winding a wire (such as a copper wire). The electromagnetic coil 121 may be a spiral coil of various shapes, for example, a circular spiral coil, a square spiral coil, an oval spiral coil, a pentagonal spiral coil, or the like. The shape of the electromagnetic coil 121 in the embodiments of the present disclosure are not limited. The electromagnetic coil 121 shown in FIG. 1B is a square spiral coil as an example.

For example, the electromagnetic coil 121 may be connected to a driving chip through a switching element. The driving chip can provide a control current to the electromagnetic coil 121 through the switching element, so as to control the electromagnetic coil 121 to form a magnetic field in the sample capture region 12. In a case where sample droplets pass through the sample capture region 12, magnetic particles in the sample droplets are gathered in the sample capture region 12 under the action of the magnetic field. For example, the magnitude of the control current can be set according to actual application requirements, and is not limited here.

For example, as shown in FIGS. 2A and 2B, the biological detection substrate 100 may comprise a base substrate 20. The droplet transmission channel 11 and the sample capture region 12 are both on the base substrate 20.

For example, the base substrate 20 may be a glass substrate, a ceramic substrate, a plastic substrate, or the like. For example, the base substrate 20 may be a printed circuit board comprising a circuit or the like.

For example, the electromagnetic coil 121 is of a planar spiral type or a three-dimensional spiral type. As shown in FIG. 2A, the electromagnetic coil 121 is of a planar spiral type, that is, wires of the electromagnetic coil 121 are located in the same layer. In a case where the electromagnetic coil 121 is of a three-dimensional spiral type, as shown in FIG. 2B, in some examples, the electromagnetic coil 121 may comprise a first portion 121a and a second portion 121b. Both the first portion 121a and the second portion 121b are of planar spiral types. A first insulating layer 22 is provided between the first portion 121a and the second portion 121b. The first insulating layer 22 comprises one or more via holes, and the first portion 121a and the second portion 121b are electrically connected through the one or more via holes. It should he noted that in a case where the electromagnetic coil 121 is of a three-dimensional spiral type, the electromagnetic coil 121 may comprises a plurality of spiral portions (for example, three spiral portions, etc.) located in different layers, and the embodiments of the present disclosure are not limited thereto. The plurality of spiral portions are electrically connected with each other. For example, in the embodiment shown in FIG. 1B, a case that the electromagnetic coil 121 may be of a planar spiral type is taken as an example.

For example, as shown in FIG. 1B, the sample capture region 12 further comprises a first driving unit, and the first driving unit (and subsequent other driving units, such as a plurality of second driving units) drives droplets by an electrowetting effect, for example. The first driving unit comprises a first driving electrode 122, and the first driving electrode 122 is formed on the base substrate 20.

For example, in the embodiments of the present disclosure, the droplet may he driven to move by a method such as electrowetting, dielectric electrophoresis, continuous oil phase driving (i.e., a multiphase flow method), or the like. The principle of electrowetting refers to the phenomenon of changing the wettability, that is, changing the contact angle, of a droplet on an insulating substrate by changing a voltage between the droplet and the insulating substrate, so as to cause deformation and displacement of the droplet. The principle of continuous oil phase driving is that: through the unique design of the fluid microchannel structure and the control of the fluid flow rate, the interaction of shear force, viscosity, and surface tension between the fluids is used to make the dispersed phase fluid generate a velocity gradient in a local area of the microchannel, so that the dispersed phase fluid is split into micro-droplets, and the generated micro-droplets are evenly distributed in continuous phases that are incompatible with each other, thus forming a monodisperse system. For example, in some examples, the microchannel structure is a T-shaped structure, water is a dispersed phase, and oil is a continuous phase. By changing the flow rate of the continuous phase, micro-droplets are generated in the channel of the T-shaped structure, and the larger the flow ratio between the continuous phase and the dispersed phase is, the faster the droplet generation rate is.

For example, in some embodiments, as shown in FIGS. 1B, 2A, and 3, the first driving electrode 122 and the electromagnetic coil 121 are located in the same layer with respect to the base substrate 20.

For example, in some examples, as shown in FIGS. 1B and 2A, the first driving electrode 122 comprises a hollow-out region, and the electromagnetic coil 121 is located in the hollow-out region, that is, the first driving electrode 122 surrounds the electromagnetic coil 121. The first driving electrode 122 may be a “ [symbol] (“hui” in Chinese characters)” shaped electrode, that is, the first driving electrode 122 has a “ [symbol] ” shape. As shown in FIG. 1B, the first driving electrode 122 is a portion between two concentric rectangles, so that the hollow-out region has a rectangular shape. However, the present disclosure is not limited thereto, the first driving electrode 122 may also be a portion between two concentric circles. In this case, the hollow-out region has a circular shape.

For example, in other examples, as shown in FIG. 3, the electromagnetic coil 121 surrounds the first driving electrode 122. In this case, the first driving electrode 122 does not comprise a hollow-out region, and the first driving electrode 122 may be, for example, a rectangular electrode.

It should be noted that, in still other examples, the first driving electrode 122 comprises a hollow-out region, and a part of the electromagnetic coil 121 is located in the hollow-out region, and the other part of the electromagnetic coil 121 surrounds the first driving electrode 122.

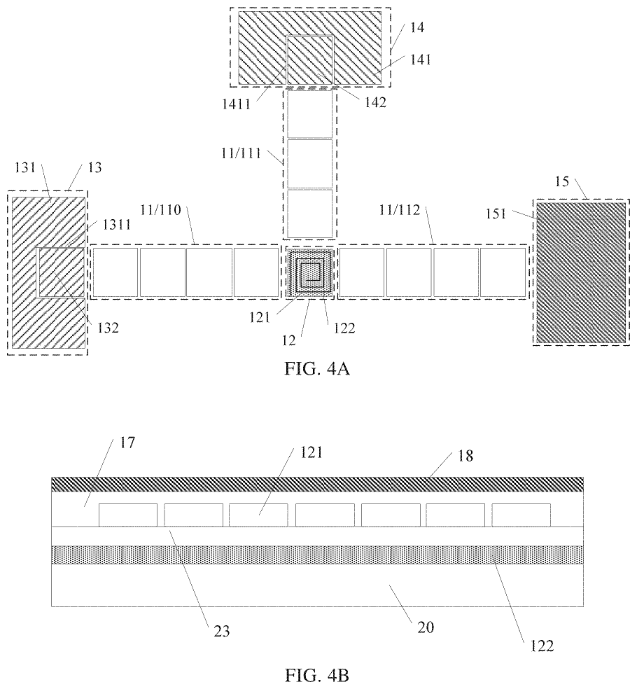

FIG. 4A is a schematic plane diagram of further another biological detection substrate provided by some embodiments of the present disclosure; and FIG. 4B is a schematic partial sectional structure diagram of further another sample capture region on a biological detection substrate provided by some embodiments of the present disclosure.

For example, in other embodiments, as shown in FIGS. 4A and 4B, the first driving electrode 122 and the electromagnetic coil 121 are located in different layers with respect to the base substrate 20. A second insulating layer 23 is provided between the first driving electrode 122 and the electromagnetic coil 121 to achieve electrical insulation between the first driving electrode 122 and the electromagnetic coil 121. In a direction perpendicular to the base substrate 20, the first driving electrode 122 and the electromagnetic coil 121 are at least partially overlapped with each other. In some examples, the first driving electrode 122 and the electromagnetic coil 121 are completely overlapped with each other. For example, an orthographic projection of the electromagnetic coil 121 on the base substrate 20 is located within an orthographic projection of the first driving electrode 122 on the base substrate 20.

For example, as shown in FIG. 4B, in a direction perpendicular to the base substrate 20, the first driving electrode 122 is on the base substrate 20, the second insulating layer 23 is on the first driving electrode 122, and the electromagnetic coil 121 is on the second insulating layer 23, that is, the electromagnetic coil 121 is farther away from the base substrate 20 than the first driving electrode 122. However, the embodiments of the present disclosure are not limited thereto. In other examples, the electromagnetic coil 121 may be on the base substrate 20, the second insulating layer 23 is on the electromagnetic coil 121, and the first driving electrode 122 is on the second insulating layer 23. That is, the electromagnetic coil 121 is closer to the base substrate 20 than the first driving electrode 122.

For example, in this example, at least the first driving electrode 122 overlapping with the electromagnetic coil 121 may be made of a soft magnetic material, and the soft magnetic material may be silicon steel sheet, permalloy, ferrite, or the like. Therefore, when the electromagnetic coil 121 is energized, the first driving electrode 122 may be magnetized to adsorb magnetic particles.

For example, a size of the first driving electrode 122 may be on the micrometer level or the millimeter level. In the example shown in FIG. 1B, a size of an outer ring of the “ [symbol] ”-shaped first driving electrode 122 may be 3*3 mm, that is, a size of the larger concentric rectangle is 3*3 mm.

For example, a size of the electromagnetic coil 121 may he set according to actual application requirements, and is not limited in the present disclosure. In the example shown in FIG. 1B, the size of the electromagnetic coil 121 is smaller than a size of an inner ring of the first driving electrode 122. In the example shown in FIG. 3, the size of the electromagnetic coil 121 may be larger than the size of the first driving electrode 122. In the example shown in FIG. 4A, the size of the electromagnetic coil 121 and the size of the first driving electrode 122 may be substantially the same.

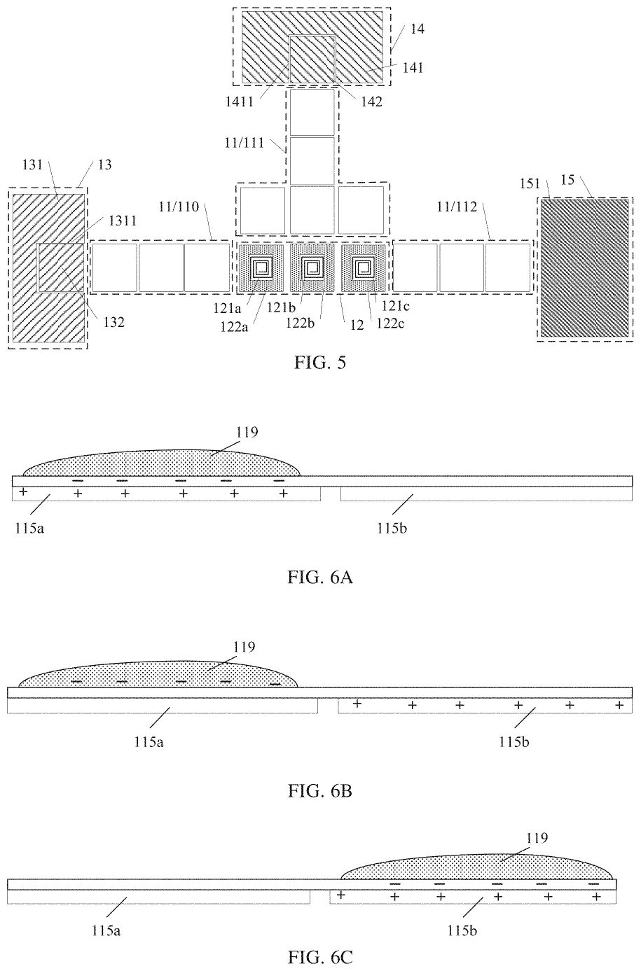

FIG. 5 is a schematic plane diagram of further another biological detection substrate provided by some embodiments of the present disclosure.

For example, in some embodiments, the sample capture region 12 further comprises a plurality of first driving units, each of the plurality of first driving units comprises a first driving electrode 122, that is, the plurality of first driving units comprise a plurality of first driving electrodes 122 in one-to-one correspondence with the plurality of first driving units. The sample capture region 12 comprises at least one electromagnetic coil 121. The plurality of first driving units are located in the same layer with respect to the base substrate 20.

For example, the plurality of first driving units and the at least one electromagnetic coil 121 are located in the same layer with respect to the base substrate 20. In some examples, the first driving electrode 122 of each of the plurality of first driving units comprises a hollow-out region, and the at least one electromagnetic coil 121 is located in the hollow-out region. For example, the sample capture region 12 may comprises a plurality of electromagnetic coils 121, and the plurality of electromagnetic coils 121 are in one-to-one correspondence with the plurality of first driving electrodes 122, and each of the electromagnetic coils 121 is located in the hollow-out region of the corresponding first driving electrode 122. As shown in FIG. 5, as an example, the sample capture region 12. comprises three first driving electrodes and three electromagnetic coils, and the three first driving electrodes are a first driving electrode 122a, a first driving electrode 122b, and a first driving electrode 122c, respectively, and the three electromagnetic coils are a first electromagnetic coil 121a, a second electromagnetic coil 121b, and a third electromagnetic coil 121c, respectively. The first electromagnetic coil 121a corresponds to the first driving electrode 122a and is located in the hollow-out region of the first driving electrode 122a; the second electromagnetic coil 121b corresponds to the first driving electrode 122b and is located in the hollow-out region of the first driving electrode 122b; and the third electromagnetic coil 121c corresponds to the first driving electrode 122c and is located in the hollow-out region of the first driving electrode 122c.

Or, in other examples, the at least one electromagnetic coil 121 surrounds the first driving electrode 122 of at least one first driving unit of the plurality of first driving units. For example, the sample capture region 12 may comprise a plurality of electromagnetic coils 121, and the plurality of electromagnetic coils 121 are in one-to-one correspondence with the plurality of first driving electrodes 122. Each electromagnetic coil 121 surrounds the corresponding first driving electrode 122. In this case, in a case where the sample capture region 12 comprises the first driving electrode 122a, the first driving electrode 122b and the first driving electrode 122c, the first electromagnetic coil 121a, the second electromagnetic coil 121b, and the third electromagnetic coil 121c, the first electromagnetic coil 121a surrounds the first driving electrode 122a; the second electromagnetic coil 121b surrounds the first driving electrode 122b; and the third electromagnetic coil 121c surrounds the first driving electrode 122c. For another example, the sample capture region 12 may also comprise one electromagnetic coil 121 that surrounds a plurality of first driving electrodes.

For another example, with respect to the base substrate, a layer where the plurality of first driving units are located is different from a layer where the at least one electromagnetic coil 121 are located. In a direction perpendicular to the base substrate 20, a first driving electrode of at least one first driving unit of the plurality of first driving units is overlapped with the at least one electromagnetic coil 121. For example, the sample capture region 12 may comprise only one electromagnetic coil 121, and in the direction perpendicular to the base substrate 20, the electromagnetic coil 121 is at least partially overlapped with each of the first driving electrodes 122. In some examples, the plurality of first driving electrodes 122 are completely overlapped with the electromagnetic coil 121. For example, an orthographic projection of the electromagnetic coil 121 on the base substrate 20 is within orthographic projections of the plurality of first driving electrodes 122 on the base substrate 20. In some other examples, the sample capture region 12 may comprise a plurality of electromagnetic coils 121, the plurality of electromagnetic coils 121 are in one-to-one correspondence with the plurality of first driving units. In a direction perpendicular to the substrate 20, the electromagnetic coil 121 is at least partially overlapped with the first driving electrode 122 of the corresponding first driving unit. The electromagnetic coil 121 and the corresponding first driving electrode 122 may be completely overlapped with each other, for example. An orthographic projection of the electromagnetic coil 121 on the base substrate 20 is within an orthographic projection of the corresponding first driving electrode 122 on the base substrate 20.

For example, in the case where the biological detection substrate 100 comprises a plurality of electromagnetic coils, the magnitudes and directions of the control currents applied to the plurality of electromagnetic coils may he the same, or the control currents applied to some of the plurality of electromagnetic coils may be different. For example, the control currents applied to some of the plurality of electromagnetic coils have different magnitudes and the same direction; or the control currents applied to some of the plurality of electromagnetic coils have the same magnitude and different directions. It should be noted that the direction of the control current indicates the flow direction of the control current in the electromagnetic coil. For example, the direction of the control current is clockwise or counterclockwise when viewed in a direction from the back surface of the biological detection substrate (bottom side in the figure) to the front surface of the biological detection substrate (top side in the figure).

For example, the first driving unit may further comprise a first switching element, and the first driving electrode 122 is connected to a first signal line through the first switching element. In a case where the first switching element is turned on, the first signal line is used to provide a driving voltage signal to the first driving electrode 122. The first switching element may be a thin film transistor, a source electrode of the thin film transistor is connected to the first driving electrode 122, a drain electrode of the thin film transistor is connected to the first signal line, and a gate electrode of the thin film transistor is used to receive a control signal.

For example, as shown in FIG. 1B, the droplet transmission channel 11 comprises a plurality of second driving units, the second driving unit drives droplets by an electrowetting effect, for example. The plurality of second driving units are arranged along a predetermined route, and the plurality of second driving units are configured to control droplets to move on the base substrate 20. Each of the plurality of second driving units comprises a second driving electrode 115.

For example, as shown in FIG. 1B, the predetermined route may comprise a first route 110, a second route 111, and a third route 112, and the first route 110, the second route 111, and the third route 112 all extend along straight lines, so that the first route 110, the second route 111, and the third route 112 all have a straight line shape. As shown in FIG. 1B, an extending direction of the first route 110 and an extending direction of the third route 112 are the same, and an extending direction of the second route 111 is different from the extending direction of the first route 110. For example, the extending direction of the first route 110 is perpendicular to the extending direction of the second route 111. However, embodiments of the present disclosure are not limited thereto, and any one of the first route 110, the second route 111, and the third route 112 may also extend along a curve line (for example, a wave shape, a zigzag shape, a polyline shape, an S-shape, or the like). For example, the first route 110, the second route 111, and the third route 112 may have the same shape. As shown in FIG. 1B, FIG. 3, and FIG, 4A, shapes of the first route 110, the second route 111, and the third route 112 are all rectangular shapes, but a size of the first route 110, a size of the second route 111, and a size of the third route 112 may be different, or the size of the first route 110 is the same as the size of the third route 112, but the size of the first route 110 and the size of the second route 111 are different from each other. For example, the first route 110, the second route 111, and the third route 112 may have different shapes. As shown in FIG. 5, the second route 111 has a T-shape, and both the first route 110 and the third route 112 have a straight line shape. The size of the first route 110 and the size of the third route 112 may be the same or different, which is not limited in the present disclosure.

For example, as shown in FIG. 1B, the second driving electrode 115 and the first driving electrode 122 are located in the same layer with respect to the base substrate 20. In a case where the electromagnetic coil 121 and the first driving electrode 122 are located in the same layer with respect to the base substrate 20, the first driving electrode 122, the second driving electrode 115, and the electromagnetic coil 121 are all located in the same layer, thereby reducing a thickness of the biological detection substrate 100, so that in a case where the biological detection substrate 100 is applied to a microfluidic chip, a thin and light microfluidic chip can be implemented. In a case where the electromagnetic coil 121 and the first driving electrode 122 are located in different layers with respect to the base substrate 20, with respect to the base substrate 20, the electromagnetic coil 121 is located in a layer different from a layer where the first driving electrode 122 and the second driving electrode 115 are located, in this case, the first driving electrode 122 and the second driving electrode 115 are closer to the base substrate 20 than the electromagnetic coil 121, or the electromagnetic coil 121 is closer to the base substrate 20 than the first driving electrode 122 and the second driving electrode 115.

It should be noted that the second driving electrode 115 and the first driving electrode 122 may also he located in different layers with respect to the base substrate 20, for example, the second driving electrode 115 and the electromagnetic coil 121 are located in the same layer, compared to the second driving electrode 115 and the electromagnetic coil 121, the first driving electrode 122 is closer to the base substrate 20; or, compared to the first driving electrode 122, the second driving electrode 115 and the electromagnetic coil 121 are closer to the base substrate 20.

For example, a size of the second driving electrode 115 may be on the micrometer level or the millimeter level. For example, the size of the second driving electrode 115 may be 3*3 mm, so that the second driving electrode 115 can better match the amount of reagents used in most biological tests. The size and shape of the sample droplet may be approximately the same as the size and shape of the second driving electrode 115. However, the embodiments of the present disclosure are not limited thereto. The size and shape of the sample droplet may also be different from the size and shape of the second driving electrode 115. For example, the shape of the second driving electrode 115 is a rectangular shape, but the shape of the sample droplet is a circular shape.

For example, the second driving electrode 115 may be made of a conductive material, such as a metal material.

For example, the first driving electrode 122 and the second driving electrode 115 may be made of the same material.

For example, the plurality of second driving electrodes 115 may have the same shape, thereby ensuring that electrical characteristics of the plurality of second driving electrodes 115 are substantially the same, furthermore ensuring the accuracy of controlling the sample droplet. As shown in FIG. 1B, a shape of the second driving electrode 115 may be a rectangular shape, for example, may be a square shape. According to actual design requirements, the shape of the second driving electrode 115 may also be a circular shape, a trapezoidal shape, or the like, and the embodiments of the present disclosure does not specifically limit the shape of the second driving electrode 115. For example, in some examples, the plurality of second driving electrodes 115 may also have different shapes. The plurality of second driving electrodes 115 are spaced apart from each other by a predetermined distance, so as to be insulated from each other.

For example, each second driving unit may further comprise a second switching element, and the second driving electrode 155 is connected to a second signal line through the second switching element. In a case where the second switching element is turned on, the second signal line is used for providing a driving voltage signal to the second driving electrode 155. The second switching element may be a thin film transistor, a source electrode of the thin film transistor is connected to the second driving electrode 115, a drain electrode of the thin film transistor is connected to the second signal line, and a gate electrode of the thin film transistor is used to receive a control signal. The plurality of second driving electrodes 115 are in one-to-one correspondence with a plurality of second signal lines, so as to achieve precise control of each second driving electrode 115.

For example, as shown in FIGS. 2A and 2B, the biological detection substrate 100 further comprises a dielectric layer 17 and a first hydrophobic layer 18. The dielectric layer 17 covers the droplet transmission channel 11 and the sample capture region 12, and the first hydrophobic layer 18 is on the dielectric layer 17. For example, the first hydrophobic layer 18 is located on a side of the dielectric layer 17 away from the droplet transmission channel 11 and the sample capture region 12. By means of the electrowetting effect, the first driving electrode 122 and the second driving electrode 115 act on the sample droplet and the cleaning droplet through the dielectric layer 17 and the first hydrophobic layer 18 during operation, in this case, the dielectric layer 17 can also protect the first driving electrode 122 and the second driving electrode 115. The first hydrophobic layer 18 can ensure the smoothness and stability of droplets (for example, the sample droplet and the cleaning droplet) during the movement process.

FIGS. 6A-6C are schematic diagrams of moving droplets by a second driving unit. FIGS. 6A-6C show a second driving electrode 115a and a second driving electrode 115b that are adjacent to each other, a dielectric layer on the second driving electrode 115a and the second driving electrode 115b, and a droplet 119 on the dielectric layer. As shown in FIG. 6A, after a positive first driving voltage signal is applied to the second driving electrode 115a on the left side of the figure, the droplet 119 moves to a position directly above the second driving electrode 115a, at this moment, the dielectric layer below the droplet 119 is coupled out corresponding negative charges, which are evenly distributed at the position directly above the corresponding second driving electrode 115a. In order to allow the droplet to move to the right side, as shown in FIG. 6B, a positive first driving voltage signal is applied to the second driving electrode 115b on the right side in the figure, and the first driving voltage signal is no longer applied to the second driving electrode 115a on the left side in the figure, in this case, a portion of the negative charges will remain on the surface of the droplet 119. Because the positive driving voltage signal is applied to the second driving electrode 115b, positive charges are generated on the second driving electrode 115b, and thus, an approximately horizontal electric field is formed between the droplet 119 and the second driving electrode 115b, so that the droplet 119 moves to the second driving electrode 115b on the right side in the figure under the action of the electric field, as shown in FIG. 6C.

For example, as shown in FIG. 1B, the biological detection substrate 100 further comprises a sample liquid injection region 13, the sample liquid injection region 13 is configured to store a sample solution containing magnetic particles and generate sample droplets, so that the sample liquid injection region 13 may also be called as a droplet generation region. The droplet transmission channel 11 comprises a first channel, and the first channel is used to connect the sample liquid injection region 13 and the sample capture region 12.

For example, the sample liquid injection region 13 may comprise a first sample liquid injection electrode 131 and a second sample liquid injection electrode 132. The first sample liquid injection electrode 131 comprises a first notch 1311, that is, the first sample liquid injection electrode 131 has a U-shape, so as to facilitate the generation of the sample droplet. The second sample liquid injection electrode 132 is located in the first notch 1311.

For example, the first sample liquid injection electrode 131 and the second sample liquid injection electrode 132 are electrically insulated from each other.

For example, the first sample liquid injection electrode 131 and the second sample liquid injection electrode 132 are located in the same layer with respect to the base substrate 20.

For example, the sample solution may be stored at the first sample liquid injection electrode 131. In a case where the sample droplet needs to be generated, first, a second driving voltage signal is applied to the first sample liquid injection electrode 131, and the second driving voltage signal is a positive voltage signal. In this case, the dielectric layer below the sample solution is coupled out corresponding negative charges, which are evenly distributed at a position directly above the first sample liquid injection electrode 131. Then, a third driving voltage signal is applied to the second sample liquid injection electrode 132, while the second driving voltage signal is no longer applied to the first sample liquid injection electrode 131, and the third driving voltage signal is also a positive voltage signal. In this case, a portion of the negative charges still remains on the surface of the sample solution on the first sample liquid injection electrode 131. Because the third driving voltage signal is applied to the second sample liquid injection electrode 132, positive charges are generated on the surface of the second sample liquid injection electrode 132, and a substantially horizontal electric field is formed between the sample solution and the second sample solution injection electrode 132. The sample solution gradually moves to the second sample liquid injection electrode 132 under the action of the electric field. After a certain period of time, a sample droplet is generated on the second sample liquid injection electrode 132. Finally, the sample droplet is moved from the second sample liquid injection electrode 132 to the droplet transmission channel 11, and then the second driving electrode 115 controls the operation (for example, the movement, splitting, mixing and other basic operations of the sample droplet) of the sample droplet on the substrate. For example, the second driving voltage signal and the third driving voltage signal may be the same or different.

For example, as shown in FIG. 1B, the first channel may be the first route 110, that is, the sample droplet may move between the sample liquid injection region 13 and the sample capture region 12 under the control of the second driving electrodes 115 in the first route 110.

For example, a shape of the sample liquid injection region 13 is a rectangular shape, and a size of the sample liquid injection region 13 is 5 mm*10 mm.

It should be noted that, shapes and sizes of the first sample liquid injection electrode 131 and the second sample liquid injection electrode 132 may he designed according to specific application requirements. For example, in some examples, the shape and size of the second sample liquid injection electrode 132 are the same as the shape and size of the second driving electrode 115. For example, the shape of the second sample liquid injection electrode 132 may he a rectangular shape, and the size of the second sample liquid injection electrode 132 may be 3*3 mm.

For example, as shown in FIG. 1B, the biological detection substrate 100 further comprises a cleaning liquid injection region 14, and the cleaning liquid injection region 14 is configured to store a cleaning solution. The droplet transmission channel 11 comprises a second channel, and the second channel is used to connect the cleaning liquid injection region 14 and the sample capture region 12.

For example, as shown in FIG. 1B, the cleaning liquid injection region 14 comprises a first cleaning liquid injection electrode 141 and a second cleaning liquid injection electrode 142. The first cleaning liquid injection electrode 141 comprises a second notch 1411, that is, the first cleaning liquid injection electrode 141 has a U-shape, so as to facilitate the generation of a cleaning droplet. The second cleaning liquid injection electrode 142 is located in the second notch 1411.

For example, the first cleaning liquid injection electrode 141 and the second cleaning liquid injection electrode 142 are electrically insulated from each other.

For example, the first cleaning liquid injection electrode 141 and the second cleaning liquid injection electrode 142 are located in the same layer with respect to the base substrate 20.

For example, the cleaning solution may be stored at the first cleaning liquid injection electrode 141, similar to the process of generating the sample droplet, in a case where a cleaning droplet needs to be generated, first, a fourth driving voltage signal is applied to the first cleaning liquid injection electrode 141, and the fourth driving voltage signal is a positive voltage signal. In this case, the dielectric layer under the cleaning solution is coupled out corresponding negative charges, which are evenly distributed at a position directly above the first cleaning liquid injection electrode 141. Then, a fifth driving voltage signal is applied to the second cleaning liquid injection electrode 1421, while the fourth driving voltage signal is no longer applied to the first cleaning liquid injection electrode 141. The fifth driving voltage signal is also a positive voltage signal, and in this case, a portion of the negative charges remains on the surface of the cleaning solution on the first cleaning liquid injection electrode 141. Because the fifth driving voltage signal is applied to the second cleaning liquid injection electrode 142, positive charges are generated on the surface of the second cleaning liquid injection electrode 142, so that a substantially horizontal electric field is formed between the cleaning solution and the second cleaning liquid injection electrode 142. The cleaning solution gradually moves to the second cleaning liquid injection electrode 142 under the action of the electric field, and after a certain period of time, the cleaning droplet is generated on the second cleaning liquid injection electrode 142. Finally, the cleaning droplet is moved from the second cleaning liquid injection electrode 142 to the droplet transmission channel 11, and then the second driving electrode 115 controls the cleaning droplet to move from the cleaning liquid injection region 14 to the sample capture region 12 for washing away other residues on the surface of the sample capture region 12 other than the biological samples, so as to reduce the interference of impurities in subsequent detection and analysis. For example, the fourth driving voltage signal and the fifth driving voltage signal may be the same or different.

For example, the cleaning solution may be a phosphate buffered solution (PBST) containing tween-20 (Polyethylene glycol sorbitan monolaurate), and so on.

For example, as shown in FIG. 1B, the second channel may be the second route 111, that is, the cleaning droplet may move between the cleaning liquid injection region 14 and the sample capture region 12 under the control of the second driving electrodes 115 in the second route 111.

For example, a shape of the cleaning liquid injection region 14 is a rectangular shape, and a size of the cleaning liquid injection region 14 is 5 mm*10 mm.

It should be noted that, shapes and sizes of the first cleaning liquid injection electrode 141 and the second cleaning liquid injection electrode 142 may be designed according to specific application requirements. For example, in some examples, the shape and size of the second cleaning liquid injection electrode 142 are the same as the shape and size of the second driving electrode 115. For example, the shape of the second cleaning liquid injection electrode 142 may be a rectangular shape, and the size of the second cleaning liquid injection electrode 142 may be 3*3 mm.

For example, the biological detection substrate 100 further comprises a waste liquid gathering region 15, and the waste liquid gathering region 15 is configured to collect and process the sample solution and the cleaning solution, that have reacted, and the like. The droplet transmission channel 11 comprises a third channel, and the third channel is used to connect the waste liquid gathering region 15 and the sample capture region 12.

For example, as shown in FIG. 1B, the third channel may he the third route 112, that is, the sample droplet and the cleaning droplet may move from the sample capture region 12 to the waste liquid gathering region 15 under the control of the second driving electrodes 115 in the third route 112.

For example, a shape of the waste liquid gathering region 15 is a rectangular shape, and a size of the waste liquid gathering region 15 is 6 mm*12 mm.

For example, as shown in FIG. 1B, the waste liquid gathering region 15 comprises a waste liquid gathering electrode 151. A shape of the waste liquid gathering electrode 151 may be a rectangular shape, and a size of the waste liquid gathering electrode 151 is 6 mm*12 mm.

It should be noted that, in the embodiments of the present disclosure, the size of the sample liquid injection region 13, the size of the cleaning liquid injection region 14, and the size of the waste liquid gathering region 15 are all exemplary, and can he changed accordingly according to actual application requirements.

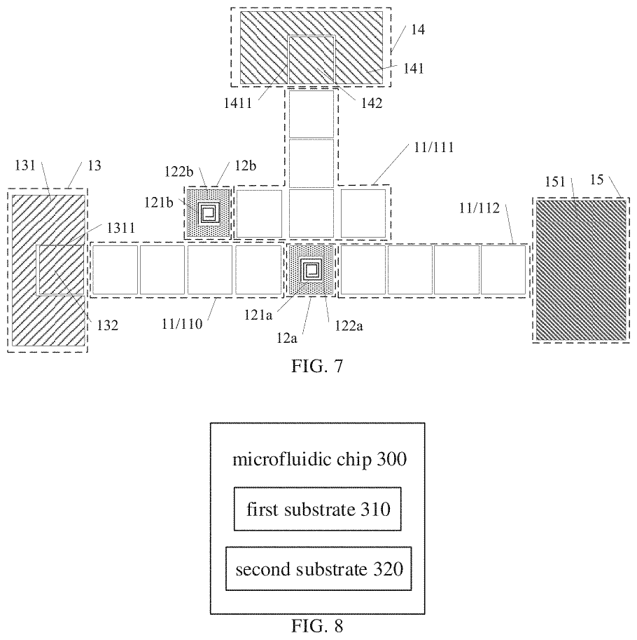

FIG. 7 is a schematic plane diagram of further another biological detection substrate provided by some embodiments of the present disclosure.

For example, in some embodiments, according to a specific application scenario, the biological detection substrate 100 comprises a plurality of sample capture regions, so that a plurality of samples can be pre-gathered at the same time in the plurality of sample capture regions. The plurality of sample capture regions are spaced apart from each other, and each sample capture region comprises an electromagnetic coil. As shown in FIG. 7, in a specific example, the biological detection substrate 100 comprises a first sample capture region 12a and a second sample capture region 12b. The first sample capture region 12a and the second sample capture region 12b are spaced from each other, that is, the first sample capture region 12a and the second sample capture region 12b are not adjacent.

For example, the first sample capture region 12a comprises a first electromagnetic coil 121a and a first driving electrode 122a, and the second sample capture region 12b comprises a second electromagnetic coil 121b and a first driving electrode 122b. The first sample capture region 12a is used to gather a first sample, and the second sample capture area 12b is used to gather a second sample. In a case where the sample droplet contains the first sample, a control current may be applied to the first electromagnetic coil 121a to form a magnetic field at the first sample capture region 12a. When the sample droplet passes through the first sample capture region 12a, the magnetic particles containing the first sample in the sample droplet are gathered at the first sample capture region 12a under the action of the magnetic field. In a case where the sample droplet contains the second sample, a control current may be applied to the second electromagnetic coil 121b to form a magnetic field at the second sample capture region 12b. When the sample droplet passes through the second sample capture region 12b, the magnetic particles containing the second sample in the sample droplet are gathered at the second sample capture region 12b under the action of the magnetic field, thereby achieving different samples to be gathered in different sample capture regions. It is worth noting that the first sample capture region 12a and the second sample capture region 12b may also be used to gather the same sample, for example, the first sample. In a case where the sample droplet contains the first sample, control currents may be applied to the first electromagnetic coil 121a and the second electromagnetic coil 121b at the same time, so that magnetic fields are formed at both the first sample capture region 12a and the second sample capture region 12b. When sample droplets pass through the first sample capture region 12a and the second sample capture region 12b, the magnetic particles containing the first sample in the sample droplets are gathered in the first sample capture region 12a and the second sample capture region 12b under the action of the magnetic fields.

For example, the control current applied to the first electromagnetic coil 121a and the control current applied to the second electromagnetic coil 121b may be the same. However, the embodiments of the present disclosure are not limited thereto, the control current applied to the first electromagnetic coil 121a and the control current applied to the second electromagnetic coil 121b may also be different. For example, the magnitude of the control current applied to the first electromagnetic coil 121a is different from the magnitude of the control current applied to the second electromagnetic coil 121b, and the direction of the control current applied to the first electromagnetic coil 121a and the direction of the control current applied to the second electromagnetic coil 121b are the same, for example, are clockwise when viewed in a direction from the back surface of the biological detection substrate (bottom side in the figure) to the front surface of the biological detection substrate (top side in the figure).

It should be noted that the shape of the droplet transmission channel can be set as required, as long as any sample capture region can be connected to the sample liquid injection region, the cleaning liquid injection region, and the waste liquid gathering region through the droplet transmission channel.

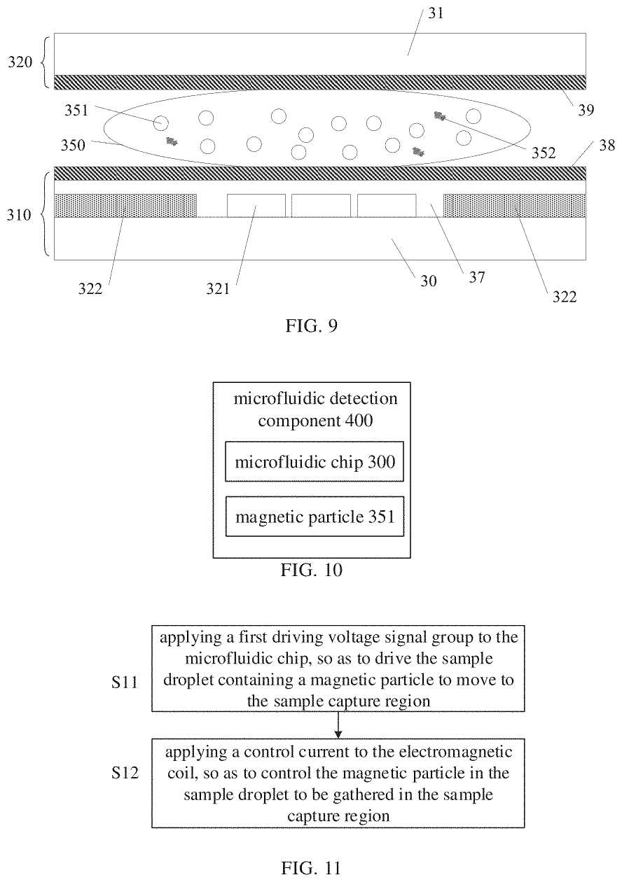

FIG. 8 is a schematic block diagram of a microfluidic chip provided by some embodiments of the present disclosure; and FIG. 9 is a schematic partial sectional structure diagram of a sample capture region in a microfluidic chip provided by some embodiments of the present disclosure.

For example, as shown in FIG. 8, a microfluidic chip 300 comprises a first substrate 310 and a second substrate 320. As shown in FIG. 9, the first substrate 310 and the second substrate 320 are opposite to each other The first substrate 310 is the biological detection substrate 100 according to any one of the above embodiments, that is, the first substrate 310 comprises a base substrate 30, a droplet transmission channel, and a sample capture region, the droplet transmission channel and the sample capture region are all on the base substrate 30. The sample capture region comprises a first driving electrode 322 and an electromagnetic coil 321, and the droplet transmission channel comprises a plurality of second driving electrodes. The first substrate 310 further comprises a dielectric layer 37 and a first hydrophobic layer 38. The dielectric layer 37 covers the droplet transmission channel 31 and the sample capture region 32, and the first hydrophobic layer 38 is located on the dielectric layer 37. For example, the first driving electrode 322, the second driving electrode, the electromagnetic coil 321, the dielectric layer 37, the first hydrophobic layer 38, and the like are all located on a side of the first substrate 310 close to the second substrate 320.

For example, as shown in FIG. 9, the second substrate 320 may comprise a base substrate 31 and a second hydrophobic layer 39. The second hydrophobic layer 39 is on the base substrate 31, and the second hydrophobic layer 39 is located on a side of the second substrate 320 close to the first substrate 320.

For example, the base substrate 31 also may be a glass substrate, a ceramic substrate, a plastic substrate, or the like.

For example, as shown in FIG. 9, a droplet 350 (a sample droplet or a cleaning droplet) is located between the first substrate 310 and the second substrate 320. The droplet 350 comprises magnetic particles 351 and impurities 352, and the biological samples to be tested are coated on surfaces of the magnetic particles 351, The magnetic particles 351 are, for example, magnetic heads.

It should he noted that related descriptions of the base substrate 30, the droplet transmission channel, the sample capture region, the first driving electrode 322, the electromagnetic coil 321, the second driving electrode, the dielectric layer 37, and the first hydrophobic layer 38 can refer to detailed descriptions of the base substrate 20, the droplet transmission channel 11, the sample capture region 12, the first driving electrode 122, the electromagnetic coil 121, the second driving electrode, the dielectric layer 17, and the first hydrophobic layer 18 of the biological detection substrate of the above embodiments, and similar portions are not repeated.

FIG. 10 is a schematic block diagram of a microfluidic detection component provided by some embodiments of the present disclosure. As shown in FIG. 10, a microfluidic detection component 400 comprises the microfluidic chip 300 according to any one of the above embodiments and a magnetic particle 351. The magnetic particle 351 is, for example, a magnetic bead. Generally, the combination of the microfluidic chip 300 and the magnetic particle 351 is provided as a detection component to the user. The user uses the magnetic particle 351 to prepare a detection sample solution, and then a corresponding detection is performed by the microfluidic chip 300.

For example, the magnetic particle 351 is configured to coat the sample to be tested on a surface of the magnetic particle 351. The magnetic particle 351 is a particle having a certain magnetic property and a special surface structure and being compounded by a magnetic particle and a material containing various active functional groups. The surface of the magnetic particle 351 usually contains functional groups with different properties such as amino, carboxyl, glutenyl, or the like, and it is easy to coat biological samples such as antibodies on the surface of the magnetic particle 351 to form the magnetic head coated with the biological samples. In the biological field, first, an antibody solution with a certain concentration (for example, an anti-influenza A virus antibody solution with a concentration of 10 ng/mL) can be prepared, then, magnetic particles 351 are added to the solution. Due to the presence of functional groups on the surfaces of the magnetic particles 351, the antibodies are adsorbed on the surfaces of the magnetic particles 351 to form the magnetic particles 351 coated with the biological samples (that is, anti-influenza A virus antibodies); finally, a biological sample solution containing the magnetic particles 351 is obtained.

For example, the magnetic particle 351 uses ferrite as a core, a shape of the magnetic particle 351 may he a spherical shape, and a diameter of the magnetic particle 351 is about 200 nm. A shape of the anti-influenza A virus antibody may also be a spherical shape, and a diameter of the anti-influenza A virus antibody is about 10 nm.

For example, the microfluidic detection component 400 may further comprise a driving chip, and the driving chip is configured to provide a driving voltage signal to the microfluidic chip 300 to control the microfluidic chip 300 to perform a series of operations on droplets (the sample droplet and the cleaning droplet), such as generating droplets, moving droplets, or the like. The driving chip may also provide a control current to the microfluidic chip 300 to control the electromagnetic coil in the microfluidic chip 300 to generate a magnetic field, so as to gather the sample in the droplet to the sample capture region.

FIG. 11 is a schematic flow diagram of a driving method of a microfluidic chip provided by some embodiments of the present disclosure. As shown in FIG. 11, the driving method comprises the following steps.

S11: applying a first driving voltage signal group to the microfluidic chip, so as to drive the sample droplet containing a magnetic particle to move to the sample capture region.

S12: applying a control current to the electromagnetic coil, so as to control the magnetic particle in the sample droplet to be gathered in the sample capture region.

For example, in step S11, the driving voltage signals comprise a plurality of first driving voltage signals, a second driving voltage signal, and a third driving voltage signal. The plurality of first driving voltage signals may be sequentially applied to the first driving electrode and the plurality of second driving electrodes in the first route in a certain order, for controlling the sample droplet to move to the sample capture region. The second driving voltage signal and the third driving voltage signal are used to control the generation of the sample droplet. For example, the second driving voltage signal is applied to the first sample liquid injection electrode in the sample liquid injection region, and the third driving voltage signal is applied to the second sample liquid injection electrode in the sample liquid injection region.

For example, in some embodiments, the driving method further comprises:

S13: applying a second driving voltage signal group to the microfluidic chip, so as to control a cleaning droplet to move to the sample capture region to achieve to clean the sample capture region.

For example, in step S13, the driving voltage signals comprise a fourth driving voltage signal, a fifth driving voltage signal, and a plurality of sixth driving voltage signals. The plurality of sixth driving voltage signals may be sequentially applied to the first driving electrode and the plurality of second driving electrodes in the second route in a certain order, for controlling the cleaning droplet to move to the sample capture region. The fourth driving voltage signal and the fifth driving voltage signal are used to control the generation of the cleaning droplet. For example, the fourth driving voltage signal is applied to the first cleaning liquid injection electrode in the cleaning liquid injection region, and the fifth driving voltage signal is applied to the second cleaning liquid injection electrode in the cleaning liquid injection region.

For example, in some embodiments, the driving method further comprises: after the magnetic particles are gathered in the sample capture region, moving the sample droplet that does not contain the magnetic particles to the waste liquid gathering region; after cleaning the sample capture region, moving the cleaning droplet to the waste liquid gathering region.

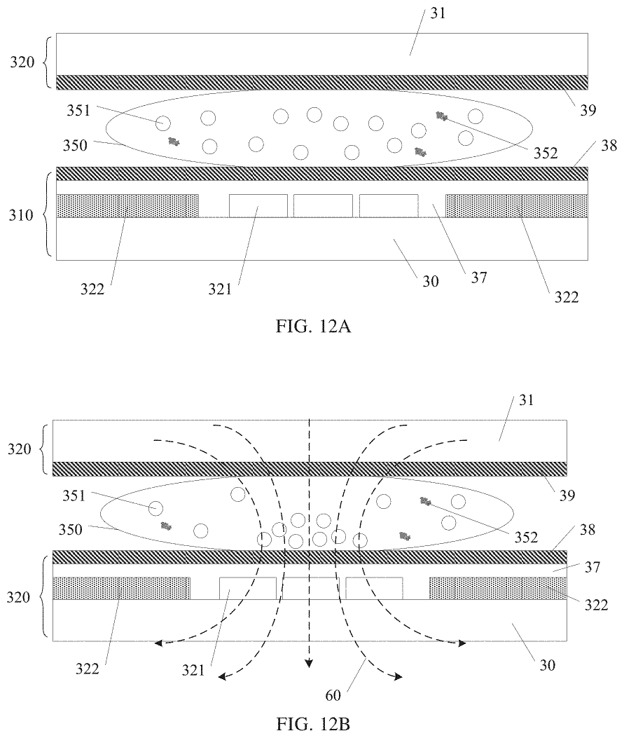

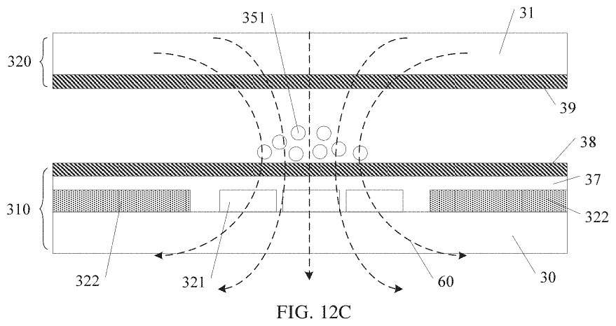

In the following, the anti-influenza A antibody is taken as an example for illustrating the gathering process of the sample in the sample droplet. FIGS. 12A-12C are schematic diagrams of a sample pre-gathered process provided by some embodiments of the present disclosure.

First, a pre-prepared sample solution containing magnetic particles is added to the sample liquid injection region. Using digital microfluidic droplet control technology, a sample droplet (the sample droplet contains magnetic particles covered by anti-influenza A antibodies) are pulled out from the sample solution and move to the sample capture region, as shown in FIG. 12A, after the sample droplet 350 moves to the sample capture region, before the samples are gathered, that is, in a case where the control current is not applied to the electromagnetic coil 321, the magnetic particles 351 coated with the virus antibodies and the other impurities 352 in the sample droplet 350 are irregularly distributed inside the entire sample droplet 350.

Then, as shown in FIG. 12B, after the control current is applied to the electromagnetic coil 321, a magnetic field 60 is generated in the sample capture region. Under the action of the magnetic field 60, the magnetic particles 351 suspended in the sample droplet 350 move toward the surface of the first driving electrode 322 in the sample capture region and are fixed after reaching the surface of the first driving electrode 322, thereby achieving the pre-gathering of the samples.

After the magnetic particles 351 are fixed on the surface of the first driving electrode 322, the sample droplet 350 is moved to the waste liquid gathering region. Then, pre-gathering of magnetic particles of the next sample droplet is performed. In a case where it is necessary to cooperate with subsequent detection, a biological cleaning solution is added to the cleaning liquid injection region, and the digital microfluidic droplet control technology is also used to generate and move a cleaning droplet to flow through the sample capture region, so as to remove possible impurities and the like in the sample capture region. The above operations are repeated for several times to complete the cleaning process. Finally, as shown in FIG. 12C, the magnetic particles 351 containing the virus antibodies gathered on the surface of the first driving electrode 322 are obtained, and then subsequent detection and analysis operations can be performed. The sample pre-gathering process can improve the sensitivity and accuracy of subsequent virus detection.

It should be noted that during the process of cleaning the sample capture region, the control current still needs to be applied to the electromagnetic coil 321, so that a magnetic field exists in the sample capture region to ensure that the magnetic particles 351 can be fixed in the sample capture region without being washed away by the cleaning droplets.

For the present disclosure, the following several statements should be noted:

(1) The accompanying drawings involve only the structure(s) in connection with the embodiment(s) of the present disclosure, and other structure(s) can be referred to common design(s).

(2) In case of no conflict, embodiments of the present disclosure and the features in the embodiments may be mutually combined to obtain new embodiments.

The above descriptions are only specific embodiments of the present disclosure, but the protection scope of the present disclosure is not limited thereto, the protection scope of the present disclosure should be determined by the protection scope of the claims.

1: A biological detection substrate, comprising: a sample capture region,
wherein the sample capture region comprises an electromagnetic coil, and the electromagnetic coil is configured to capture a sample in a sample droplet that is driven to pass through the sample capture region.

2: The biological detection substrate according to claim 1, further comprising: a droplet transmission channel,
wherein the droplet transmission channel is in connection with the sample capture region, and is configured to drive the sample droplet, which is injected and contains the sample, to the sample capture region.

3: The biological detection substrate according to claim 2, wherein the sample capture region further comprises a first driving unit, and the first driving unit comprises a first driving electrode.

4: The biological detection substrate according to claim 3, further comprising a base substrate,
wherein the droplet transmission channel and the sample capture region are on the base substrate,
the first driving electrode and the electromagnetic coil are in a same layer with respect to the base substrate, the first driving electrode comprises a hollow-out region, and the electromagnetic coil is in the hollow-out region; or the electromagnetic coil surrounds the first driving electrode.

5: The biological detection substrate according to claim 3, further comprising a base substrate,
wherein the droplet transmission channel and the sample capture region are on the base substrate,
the first driving electrode and the electromagnetic coil are in different layers with respect to the base substrate, and in a direction perpendicular to the base substrate, the first driving electrode and the electromagnetic coil are at least partially overlapped with each other.

6: The biological detection substrate according to claim 2, wherein the sample capture region further comprises a plurality of first driving units, each of the plurality of first driving units comprises a first driving electrode, and the sample capture region comprises at least one electromagnetic coil.

7: The biological detection substrate according to claim 6, further comprising a base substrate,
wherein the droplet transmission channel and the sample capture region are on the base substrate,
the plurality of first driving units and the at least one electromagnetic coil are in a same layer with respect to the base substrate,
the first driving electrode of at least one first driving unit of the plurality of first driving units comprises a hollow-out region, and the at least one electromagnetic coil is in the hollow-out region; or the at least one electromagnetic coil surrounds the first driving electrode of the at least one first driving unit of the plurality of first driving units.

8: The biological detection substrate according to claim 6, further comprising a base substrate,
wherein the droplet transmission channel and the sample capture region are on the base substrate,
the plurality of first driving units are in a same layer with respect to the base substrate, and with respect to the base substrate, a layer where the plurality of first driving units are located is different from a layer where the at least one electromagnetic coil are located,
in a direction perpendicular to the base substrate, the first driving electrode of at least one first driving unit of the plurality of first driving units and the at least one electromagnetic coil are overlapped with each other.

9. (canceled)

10: The biological detection substrate according to claim 3, wherein the droplet transmission channel comprises a plurality of second driving units,
the plurality of second driving units are arranged along a predetermined route, and each of the plurality of second driving units comprises a second driving electrode.

11-12. (canceled)

13: The biological detection substrate according to claim 2, further comprising a sample liquid injection region,
wherein the droplet transmission channel comprises a first channel, and the first channel is configured to connect the sample liquid injection region and the sample capture region.

14: The biological detection substrate according to claim 13, wherein the sample liquid injection region comprises a first sample liquid injection electrode and a second sample liquid injection electrode,
the first sample liquid injection electrode comprises a first notch, and the second sample liquid injection electrode is in the first notch.

15: The biological detection substrate according to claim 2, further comprising a cleaning liquid injection region,
wherein the droplet transmission channel comprises a second channel, and the second channel is configured to connect the cleaning liquid injection region and the sample capture region.

16: The biological detection substrate according to claim 15, wherein the cleaning liquid injection region comprises a first cleaning liquid injection electrode and a second cleaning liquid injection electrode,
the first cleaning liquid injection electrode comprises a second notch, and the second cleaning liquid injection electrode is in the second notch.

17: The biological detection substrate according to claim 2, further comprising a waste liquid gathering region,
wherein the waste liquid gathering region comprises a waste liquid gathering electrode,
the droplet transmission channel comprises a third channel, and the third channel is configured to connect the waste liquid gathering region and the sample capture region.

18: The biological detection substrate according to claim 2, further comprising a dielectric layer and a first hydrophobic layer,
wherein the dielectric layer covers the droplet transmission channel and the sample capture region, and the first hydrophobic layer is on a side of the dielectric layer away from the droplet transmission channel and the sample capture region.

19: A microfluidic chip, comprising: a first substrate and a second substrate,
wherein the first substrate and the second substrate are disposed opposite to each other, and the first substrate comprises a sample capture region, the sample capture region comprises an electromagnetic coil, and the electromagnetic coil is used to capture a sample in a sample droplet that is driven to pass through the sample capture region.

20. (canceled)

21: A microfluidic detection component, comprising:
a microfluidic chip, and
a magnetic particle,
wherein the microfluidic chip comprises: a first substrate and a second substrate,
the first substrate and the second substrate are disposed opposite to each other, and the first substrate comprises a sample capture region, the sample capture region comprises an electromagnetic coil, and the electromagnetic coil is used to capture a sample in a sample droplet that is driven to pass through the sample capture region.

22: The microfluidic detection component according to claim 21, wherein the magnetic particle is configured to be capable of coating a sample to be tested on a surface of the magnetic particle.

23: A driving method of the microfluidic chip according to claim 19, comprising:
applying a first driving voltage signal group to the microfluidic chip, so as to drive the sample droplet containing a magnetic particle to move to the sample capture region; and
applying a control current to the electromagnetic coil, so as to control the magnetic particle in the sample droplet to be gathered in the sample capture region.

24: The driving method according to claim 23, further comprising:
applying a second driving voltage signal group to the microfluidic chip, so as to control a cleaning droplet to move to the sample capture region to achieve to clean the sample capture region.
